(19) United States
(12) Patent Application Publication
(10) Pub. No.: US 2010/0305484 A1
(43) Pub. Date: Dec. 2, 2010

(54) USES OF ELECTROACTIVE MATERIAL ACTUATORS IN COSMETICS

(76) Inventors: Jean-Francois Grollier, Paris (FR); Henri Samain, Bievres (FR)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/746,685

(22) PCT Filed: Dec. 5, 2008
(86) PCT No.: PCT/IB08/55124

§ 371 Date: Aug. 11, 2010

Related U.S. Application Data
(60) Provisional application No. 61/129,244, filed on Jun. 13, 2008.

(30) Foreign Application Priority Data
Dec. 6, 2007 (FR) 0759628
Apr. 11, 2008 (FR) 0852434

(51) Int. Cl. A61H 7/00

(52) U.S. Cl. 601/84

(57) ABSTRACT

The present invention relates to a cosmetic treatment method comprising: a1) putting into place on keratinous material at least one actuator (1) of electroactive material, preferably electroactive polymer material; b1) exciting the actuator (1) to apply to the keratinous material a force that is substantially parallel thereto and that induces a displacement thereof, which displacement persists, at least while the actuator (1) is in place; or a2) exciting the actuator (1) so as to induce deformation thereof; b2) putting the actuator (1) into place, in particular by fastening it on keratinous material; and c2) modifying the excitation of the actuator (1), so that the actuator (1) induces a displacement of the keratinous material.

The present invention relates in particular to methods and devices enabling the appearance of a person to be modified and to methods and devices concerning the application of a composition to keratinous material.

It is known to apply compositions to the skin that have a tensioning effect for the purpose of diminishing the visibility of wrinkles.

The effect of such compositions can fail to last as long as desired.

Furthermore, their effect is limited since, after contracting a certain amount, tensioning materials start cracking. Tension is thus restricted to small zones, typically of a few millimeters.

Furthermore, tensioning materials can apply contractile forces only. They cannot give rise to extension effects.

Finally their effect is neither variable nor adjustable. As a result, if the new shape is not the shape desired, there is no way to increase or decrease the effect.

Plastic surgery enables the face or the body to be transformed durably. Nevertheless, there are numerous situations in which a temporary modification in the appearance of a person suffices, for example when participating in a show.

U.S. Pat. No. 6,937,893 discloses a patch including an electrostrictive polymer for acting electro-mechanically on the skin. An application to treating wrinkles by exciting the polymer with a cyclical voltage is disclosed.

Publication WO 99/56829 discloses bandages provided with ultrasonic transducers for accelerating the healing of wounds.

EP 1324 403 discloses a wearable human motion applicator for assisting or inducing a motion as intended by a human being.

EP 1 645 255 discloses an electroactive compression bandage that encloses at least partially a body part and that is configured to apply pressure to the body part.

There exists a need to benefit from novel means that enable the appearance of a person to be modified.

Exemplary embodiments of the invention provide solutions that enable the appearance of a person to be modified temporarily, and other exemplary embodiments of the invention provide novel methods of acting on keratinous material, e.g. in order to apply a composition, in particular a cosmetic.

In general terms, the invention relies on using at least one actuator, in particular an electroactive polymer actuator.

Electroactive polymer actuators are described in various publications, including the following: US 2007/0114116 A1, U.S. Pat. No. 6,109,852, U.S. Pat. No. 5,389,222, U.S. Pat. No. 5,250,167, U.S. Pat. No. 6,475,639, and WO 01/80284, e.g. to make controllable catheters or artificial muscles for prostheses or robots.

Exemplary embodiments of the invention provide a cosmetic treatment method comprising:

a) putting into place on keratinous material at least one actuator of electroactive material, preferably electroactive polymer material;

b) exciting the actuator to induce a displacement of the keratinous material, which displacement persists at least while the actuator is in place.

The term “a displacement that persists” should be understood to cover a displacement that is not cyclical, even if the displacement can be of amplitude that is not constant over time.

Exciting the actuator may apply to the keratinous material a force that is substantially parallel thereto and that induces a displacement thereof.

The displacement is for example a unidirectional displacement, i.e. a displacement different from a displacement that makes the keratinous material move alternatively in two opposite directions.

The induced displacement may be a confined displacement, such a confined displacement being for example different from a displacement that also moves a clothing worn by the user.

The induced displacement may be different from a displacement for assisting or inducing the displacement of a part of the body of a human being, in particular a limb. The keratinous material are for example located on a limb comprising a bone and the induced displacement does not cause said bone to move.

Exciting the actuator may induce a displacement of the keratinous material in the vicinity of a body joint without displacing the bones of the joint.

The keratinous material may define a plane and the applied force may be substantially contained in said plane.

In a variant, the keratinous material may have a concave or convex shape, comprising a plurality of portions defining locally a succession of planes and the applied force to a portion of the keratinous material may be substantially contained in the plane defined by said portion.

A force substantially contained in the plane of the keratinous material is for example a force that, when decomposed into a tangential component lying in the plane of the keratinous material and a normal component, is such that the tangential component presents a norm greater than the norm of the normal component.

Moving keratinous material may lead to a change in the appearance of the person, which change may be seen when the actuator is in place.

The displacement may be the result of applying to the actuator a voltage that is not cyclical, and of unchanging polarity.

Throughout the description, the term “cosmetic treatment” should be understood broadly, and in particular as covering a change to the appearance of keratinous material.

The actuator may be put into place on keratinous material by fastening the actuator with adhesive or with other means, such as suction cups, for example.

The keratinous material may be selected from the skin, the mucous membranes, and keratinous fibers, in particular the hair, or eyelashes.

The excitation may be of electrical origin or of other origin, e.g. of optical, biological, chemical, or thermal origin.

By way of example, the actuator may include one or more compounds capable of transforming an external stimulus, e.g. light radiation, a supply of heat, or a mechanical stress, into a potential difference that leads to an excitation of the actuator. For this purpose, it is possible to use one or more photovoltaic cells that produce an electric voltage when irradiated.

After the actuator has been excited, the keratinous material may be maintained substantially in the configuration in which the actuator has taken it, by sticking a holder film on the keratinous material or by applying a film-forming composition that prevents the keratinous material from moving by forming a film. For example, it is possible to use: an adhesive strip, e.g. of the Scotch® trademark; an adhesive dressing; a spray, typically a hairspray, containing a resin type polymer, a solvent, and a propellant; a liquid dressing; or a solution of adhesive, e.g. a cyanoacrylate adhesive.

After the holder film or the film-forming composition has been applied, the actuator may optionally be removed, if that is still possible. The actuator may also be left in place. Nevertheless, it is possible to remove the electrical conductors for powering it.

Prior to being placed on keratinous material, the actuator may be cut to a format that depends on the keratinous material to be treated.

The actuator may be excited gradually so as to induce a corresponding force and/or displacement progressively, e.g. in order to enable the user to see the degree of actuator excitation that is suitable for obtaining the desired result or to enable the degree of expansion or contraction of the actuator to be adjusted finely.

Other exemplary embodiments of the invention provide a method of cosmetically treating a person, the method including: a) exciting at least one electroactive material actuator, preferably an electroactive polymer actuator, gradually so as to induce a corresponding force and/or displacement progressively on the keratinous material.

The actuator may be excited in response to the action of the user on control means, e.g. moving a knob or a slider or inputting data via a keypad or a touch screen. The control means may control the amplitude of an excitation voltage and/or an excitation polarity, and/or an excitation frequency, or some other parameter.

The electrical excitation of the actuator may be automated, at least in part, and may be performed for example in response to prior acquisition of at least one typological characteristic of the person, e.g. an image of the face or of the body, or in response to at least one signal coming from a sensor, in particular a sensor worn on the person, for example a pressure sensor, a displacement sensor, a moisture sensor, a light-sensitive sensor, etc.

The method may thus include acquiring at least one image of the body or the face of a person, automatically determining a correction to be applied by means of the actuator(s) or enabling the user to input the desired correction, and automatically controlling the actuator(s) so as to induce a force and/or a displacement on the keratinous material giving rise to a modification to the appearance of the keratinous material that corresponds to the looked-for correction.

The method may be implemented to make the person more attractive, to change the person's appearance, to correct asymmetries, or to make the person look older, e.g. for a theatrical purpose.

The method may also be implemented so that the force and/or the displacement exerted by the actuator on the keratinous material tends to exert action that persists after the actuator has been removed. For example, the actuator may be used to tension the skin locally on either side of a wrinkle, so as to reduce the depth of the wrinkle and/or enable tissue to be reconstructed in a particular configuration. The mechanical stress may be exerted on the skin overnight, for example, so as to make the wrinkle less visible during the day. Under such circumstances, the actuator that is used may, for example, be an actuator that expands on being powered electrically.

Other exemplary embodiments of the invention provide a cosmetic treatment method in which at least one electroactive material actuator, preferably an electroactive polymer material actuator, is applied to the keratinous material, and in particular to the skin, for a duration that is longer than 10 minutes (min), better longer than 60 min, or indeed longer than 3 hours (h), or even 6 h or 12 h, the actuator being applied, for example, overnight and removed for the day. Subjecting the keratinous material to prolonged mechanical action may encourage tissue reorganization, e.g. collagen to reform.

Other exemplary embodiments of the invention provide a device for implementing such a method, the device comprising an actuator arranged to be worn while in use for the above duration, and including the corresponding electrical power supply.

The force and/or the displacement that is exerted on the keratinous material may also seek to perform a massage action, in particular when the force and/or the displacement is modulated over time. By way of example, the massage may seek to confer a sensation of well-being, to develop muscle, to stimulate nerve terminations, and/or to enhance the action of a cosmetic or dermatological composition.

The electrical excitation of the actuator may take place in repeated cycles in order to exert a non-constant force and/or reciprocating motion on the skin. An advantage associated with using an electroactive polymer actuator is to benefit from the small thickness of the actuator, thus possibly making it possible to perform treatment under garments or under a masking film that has the appearance of the underlying keratinous material.

The actuator may be used to move an eyelid, e.g. a lower eyelid. An actuator that contracts when a voltage is applied may be fastened via one end to the eyelid and via its other end to the cheeks, for example.

A plurality of actuators may be used simultaneously, and each of the actuators may be excited to an individually controllable level. The degree of excitation of the various actuators depends for example on an appearance that it is desired to reproduce, said appearance being selected by the user from amongst a variety of appearances, for example. The method may include automatically calculating the voltage to be applied to each actuator in order to deform the keratinous material so as to obtain the looked-for appearance.

At least one actuator may be used to act on a lower eyelid and at least one other actuator may be used to act on the corresponding upper eyelid. By way of example, each actuator has one end that is fastened to the corresponding eyelid, immediately beneath or above the eyelashes, respectively.

A plurality of actuators may each have one end fastened to a lower eyelid and an opposite end to a cheek, and the actuators are contracted so as to obtain the deformation desired for the eyelid.

An actuator may be used that is capable of contracting when powered electrically, the actuator having one end fastened to an ear and the other end to the head, and the actuator is excited electrically in order to move the ear towards the head, e.g. for the purpose of making the ears symmetrical when one of the ears sticks out farther than the other. Contraction of the actuator may take place progressively, and the ear may be held in the looked-for configuration by using an adhesive, for example.

The actuator may also be used as a force or displacement sensor, for example when it is not excited electrically.

The actuator(s) may be used to modify the appearance of the body or the face prior to performing plastic surgery, so as to enable the person on whom the surgery is to be performed and/or the surgeon to obtain an indication about the result of the operation.

In general, the actuator(s) used may be masked by a masking film and/or by makeup so as to be as invisible as possible, in particular once the looked-for displacement has been obtained.

Other exemplary embodiments of the invention provide a method of making up keratinous material in which a makeup composition is applied not only to the keratinous material but also to an actuator including an electroactive material, preferably an electroactive polymer material, or to a holder film covering the actuator.

The actuator(s) may also be initially colored to have the color of the underlying keratinous material or to present a surface state that is rough or porous so as to enable a makeup composition such as a foundation, for example, to be applied thereto and to remain thereon.

Other exemplary embodiments of the invention provide a method of applying a composition, in particular a cosmetic composition, on keratinous material, the method including:
exciting an electroactive material actuator, preferably an electroactive polymer material actuator, so as to exert a force and/or move the keratinous material in the zone where the composition is applied.

Such a method may:
enhance penetration of the composition, e.g. by performing a massage action on the keratinous material in the zone where the composition is applied; and/or
facilitate renewal of the composition at the interface with the keratinous material; and/or
exert pressure tending to force the composition to penetrate into the keratinous material; and/or
blur the outline of the application zone, which can be useful when applying foundation makeup or a self-tanning agent, for example.

The displacement of the actuator may be reciprocating motion, with the frequency of the extensions/contractions of the actuator lying in the range 1 per minute to 500 per second, for example.

The composition may be applied to the keratinous material before the actuator is brought into contact therewith. In a variant, the composition is applied to the actuator and the actuator is then applied to the keratinous material. The actuator may also include at least one opening or channel enabling the composition to be taken to the keratinous material while the actuator is in place. Where appropriate, the actuator may be preimpregnated with the composition for application and may be packaged in a receptacle enabling the composition to be conserved, e.g. a sealed receptacle.

When the actuator is excited, it may optionally be fastened to the keratinous material. In order to perform a massaging or exfoliation action and/or in order to apply a composition, it may suffice for the actuator to be in contact with the keratinous material without being fastened thereto. For example, the actuator may be held in the user's hand or may be held against the keratinous material by appropriate means.

The actuator may be incorporated in a garment or an undergarment, the appliance that is for delivering the stimulation voltage to the actuator also being incorporated in the garment, for example.

One or more actuators may be incorporated in a patch or mask for placing on the face, in a belt for placing around the waist or the thighs, or in panties or in trousers.

When the actuator is for exerting a massage or exfoliation action and/or for applying a composition, the area in contact with the skin that is set into motion by the actuator may be flocked or may be defined by a foam, or a woven or non-woven fabric, that is optionally impregnated with the composition. Where necessary, the contact surface may be slightly abrasive, in order to perform dermabrasion.

Other exemplary embodiments of the invention provide a kit comprising:
at least one electroactive material actuator, preferably an electroactive polymer material actuator; and
at least one composition for applying to the keratinous material, in particular a cosmetic or a dermatological composition.

Other exemplary embodiments of the invention provide a kit comprising:
at least one electroactive material actuator, preferably an electroactive polymer material actuator; and
at least one holder film or film-forming composition for application to the keratinous material in order to hold it in a configuration into which the actuator has brought it.

By way of example, the holder film is adhesive, e.g. comprising one or more adhesive zones each covered in a respective removable protective coating. The adhesive is preferably hypoallergic. The film need not be adhesive and the kit may include a separately-packaged adhesive for sticking the holder film to the keratinous material. The holder film may optionally have the same appearance as the underlying keratinous material and/or it may be suitable for being made up.

In all of these kits, the actuator may be at least partially transparent or may present a face having substantially the same color as the underlying keratinous material or that is capable of being made up.

Each of the above kits may be contained in a single package, such as, for example: a box, a case, or a blister pack. The kit may contain one or more actuators that are reusable, or that are for single use only. The actuator(s) may be placed in sterile individual packaging, where appropriate. The actuators may be packaged already connected to electrical conductors for powering them.

Other exemplary embodiments of the invention provide a massage device comprising at least one electroactive material actuator, preferably an electroactive polymer material actuator, and an appliance enabling the actuator to be powered electrically so as to induce periodic displacements of the actuator.

The actuator may contract or expand in response to a voltage of unchanging polarity being applied thereto with an amplitude that varies, or it may be an actuator that is capable of both contracting and expanding depending on the polarity of the applied voltage.

Where appropriate, and as mentioned above, the massage device may be incorporated in a garment or an undergarment, or in a patch or a mask.

The massage device may be used with the actuator(s) being provided in at least one garment.

The massage device may be used before or after applying a cosmetic composition, e.g. a massage oil, a moisturizing cream, a thinning or exfoliating agent, a self-tanning agent, . . . .

Where appropriate, the actuator may be arranged to heat on being powered electrically, either because of heat being dissipated in the electroactive polymer or because of heat being dissipated in one or more resistive heater elements connected in parallel or in series with the electroactive polymer or connected to a separate electrical power supply.

The massage device may also include at least one Peltier effect component for cooling the keratinous material when powered electrically.

The massage device may include at least one electrode that comes into contact with the skin in order to enable the keratinous material to be stimulated electrically in addition to being stimulated mechanically.

Other exemplary embodiments of the invention provide a method of fabricating an actuator, in which the actuator is formed by successively depositing electrodes and an electroactive polymer on the keratinous material, optionally with a barrier-forming film being interposed between said elements and the keratinous material.

Other exemplary embodiments of the invention provide a method of fabricating an actuator, wherein the electroactive polymer is molded or shaped while hot, so as to take the shape of the keratinous material onto which the actuator is to be placed. This makes it possible to obtain an actuator that fits more closely to the shape of the region of the body or the face that is to be subjected to excitation by the actuator.

The electrodes of the actuator may be made on the electroactive polymer as molded or hot-shaped in this way, or in a variant, the electrodes may already be present on the electroactive polymer when it is given the desired shape.

Other exemplary embodiments of the invention provide a device for applying to keratinous material, the device comprising an electroactive material actuator, preferably an electroactive polymer material actuator, and a source of electricity that is incorporated in the device, e.g. a battery, which source may optionally be made by a printing technique. The battery may be carried on a support in common with the actuator, e.g. a flexible film. Batteries made by printing are known and can be obtained from the supplier Powerpaper, in particular.

The device may be in the form of a sheet, e.g. a patch or a mask, where appropriate together with a control circuit that governs the power supplied to the electroactive polymer. The control circuit may for example include a system that enables the operation of the patch to be triggered once it has been applied to the keratinous material.

Other exemplary embodiments of the invention provide a sheet device for applying on keratinous material, which device incorporates at least one electroactive material actuator, preferably an electroactive polymer material actuator, and presents at least one optical layer that produces an optical effect and that is arranged to accompany the mechanical deformation of the actuator with its appearance changing as a function of said deformation.

By way of example, the optical layer comprises an interference structure of color that changes as a function of the extent to which the actuator expands or contracts, e.g. by changing the distance between diffracting patterns within a diffraction grating. The optical layer may define the outer face of the device.

After being applied to the keratinous material, the deformation of the actuator may be adjusted, for example, so that the appearance of the optical layer corresponds to the appearance of adjacent keratinous material, thus effectively hiding a defect.

Other exemplary embodiments of the invention provide a device comprising:
an electroactive material actuator, preferably an electroactive polymer material actuator;
a sensor; and
a circuit for controlling the actuator as a function of at least one signal delivered by the sensor, the actuator being arranged to be fastened on keratinous material.

The sensor may be arranged to fasten on keratinous material, and may for example be arranged to detect relaxation of the skin, the device including a circuit arranged to excite the actuator in response to detecting such relaxation so as to re-tension the skin. The actuator may be placed on a zone that runs the risk of giving rise to wrinkles, e.g. around the eyes, in order to retard the appearance of wrinkles.

Other exemplary embodiments of the invention provide a cosmetic treatment method, the method comprising:

a) exciting at least one electroactive material actuator so as to induce deformation thereof:

b) putting the actuator into place on keratinous material, in particular by fastening it thereto; and

c) modifying the excitation of the actuator so that the actuator induces a displacement of the keratinous material.

The actuator may be elastically deformable and may induce displacement of the keratinous material by returning towards its initial configuration.

The modification of the excitation in above step c) may correspond to stopping excitation. Stopping the electrical excitation of the actuator may be accompanied by disconnecting electrical conductors powering the actuator.

The actuator may be used while fastened to the body, so as to change the appearance of the bust.

In a variant, the actuator may be fastened on the face so as to lift the skin around the outline of the face.

The actuator may also be fastened to the face in such a manner as to act on a lower or upper eyelid, in particular in order to enlarge an eye.

The actuator may optionally come into contact with the skin.

The actuator may be stuck to the skin or it may be fastened to a garment or an undergarment. For example, it is possible for only the end regions of the actuator to be stuck to the skin.

The actuator may be stuck to the skin using a pressure-sensitive adhesive.

The actuator may be used to work the skin mechanically so as to develop muscle.

Other exemplary embodiments of the invention provide a method of creating a face-lift effect on the skin of the face or of the body, in which the electroactive material actuator is caused to extend by applying a voltage thereto, the actuator is then fastened to the skin, and the electrical excitation of the actuator is modified, in particular is interrupted, so as to enable the actuator to shrink.

The actuator may then be hidden by makeup.

Such a method may include the step consisting in the person for treatment evaluating the degree of actuator contraction that is required to achieve the looked-for result, and in adjusting the voltage so as to obtain the desired extension or contraction of the actuator after interrupting the electrical excitation.

The actuator may be fastened to the skin by being stuck thereto before interrupting electrical excitation, and fastening may take place via two opposite ends of the actuator.

This method may be of use in particular for lifting the outline of the face. The length through which the skin needs to be lifted may be estimated, e.g. by applying a finger to a corner of the jaw and moving the finger up towards the temples. By way of example, it may be decided to use the actuator to lift the skin through a distance that lies in the range one-third to two-thirds, e.g. half, the total distance through which the finger may move the skin.

An the advantage associated with using an actuator is that the distance over which the actuator pulls the skin may be adjusted relatively accurately.

Other exemplary embodiments of the invention also provide a method of raising the bust, in particular at least one breast, in which an actuator is used to which a voltage is applied to cause it to extend, the actuator then having its ends fastened to regions of the body, and then the electrical excitation of the actuator is modified, in particular it is interrupted, so as to cause the actuator to contract and obtain the looked-for lifting of the bust.

The actuator may have its ends fastened to firm regions of the body while leaving the breast to rest, e.g. freely, on an intermediate zone of the actuator.

The actuator may also have its ends fastened to soft regions of the body.

The actuator may present end regions that are enlarged and/or of greater thickness, which may make it easier to fasten.

Other exemplary embodiments of the invention provide a method of modifying the outline of the eye, in which method a voltage is applied to an actuator in order to cause it to become elongated, the actuator is fastened to regions in the vicinity of the eye, and then the electrical excitation of the actuator is modified, in particular is interrupted, so as to cause the actuator to shrink and the appearance of the vicinity of the eye to be modified.

By way of example, the applicator used in this example may present, prior to electrical excitation, a length that is less than or equal to 30 millimeters (mm) and a width that is less than or equal to 30 mm, e.g. a length of about 20 mm and a width of about 20 mm. The actuator may present a center layer that is less than 50 micrometers (μm) thick, and electrode layers and outer layers each of which is, for example, less than 15 μm thick. The actuator may be used for raising a slanting eyelid.

Other exemplary embodiments of the invention provide the use of an actuator for mechanically working a region of an individual's body, in which method the actuator performs contraction and extension cycles while being placed on the skin so that the skin accompanies the displacement of the actuator, at least in part.

This may be used to treat the cheeks or the regions under the eyes.

Other exemplary embodiments of the invention provide a cosmetic treatment method wherein an electroactive material actuator, preferably an electroactive polymer material actuator, is excited cyclically so as to act on a region of the body or the face, and wherein at least one of the amplitude and the frequency of the excitation is determined as a function of information coming from the subject on which the actuator is placed.

The method may include determining the amplitude and the frequency of the mechanical actions so that they do not give rise to discomfort for the user.

In a prior stage, it is possible for example to vary the frequency, e.g. over the range 0.001 hertz (Hz) to 5000 Hz, and also to vary the applied voltage, e.g. over the range 0 to 10,000 volts (V).

The frequency and the voltage may be modified as a function of information provided by the user being subjected to mechanical working by the actuator, so as to determine which values are the most comfortable. By way of example, the values preferred by the user may be stored in a device that controls excitation of the actuator. A plurality of frequency and/or voltage values may be applied in succession, so as to give the user the opportunity to make a selection.

Other exemplary embodiments of the invention provide the use of an electroactive material actuator, in particular an electroactive polymer material actuator, for preventing stretch marks.

The actuator may be used on a region that is liable to suffer from stretch marks.

In particular, the actuator may be used by women during periods in which the body is liable to become larger, advantageously being used in association with weight monitoring.

The application may take place for example on portions of the body such as the thighs, the buttocks, the breasts, and the stomach. The actuator may be applied to the region for treatment and the electrical excitation of the actuator may be changed so that the actuator is subjected to contraction and extension cycles.

By way of example, the voltage may be applied for a period of at least one minute and then interrupted for a period of at least one minute.

Exemplary embodiments of the invention may be used for treating painful skin, in particular skin made painful by the sun, using the actuator to perform extension and/or compression cycles during the period following the appearance of erythemia and until the erythemia disappears.

Where appropriate, treatment of the skin by means of extension and compression cycles may be performed after exposure to the skin but before erythemia appears.

The actuator may be used with or without an added composition.

The actuator may include at least one hole enabling a composition to be applied and to diffuse therethrough, e.g. a fatty fluid, with such diffusion taking place for example towards the skin.

The actuator may include an adhesive for sticking to the skin, which adhesive contains at least one agent that acts on the skin, e.g. an analgesic.

The actuator may be incorporated in a garment or an undergarment.

Other exemplary embodiments of the invention provide an epilation method in which an electroactive material actuator, in particular an electroactive polymer material actuator is put into contact with the skin, this exciter being secured to a patch, in particular a textile patch, that is suitable for exerting a depilatory effect on the skin under the effect of displacements of said patch induced by deformations of the actuator, in particular cyclical deformations.

Other exemplary embodiments of the invention provide a cosmetic treatment method wherein an electroactive material actuator is excited cyclically so as to act on a region of the body or the face, and wherein at least one of the amplitude and the frequency of the excitation is determined as a function of information coming from the subject on which the actuator is placed.

Other exemplary embodiments of the invention provide a cosmetic treatment method wherein an electroactive material actuator is used to work the skin mechanically after exposure to the sun that might lead to erythemia.

Other exemplary embodiments of the invention provide a textile article that is to be worn by an individual, in particular a woven article, comprising a plurality of actuators in the form of yarns, in particular yarns in the form of strips, that are incorporated in the textile patch, in particular in the weave of the fabric, possibly together with a source of electricity for exciting the actuators and carried by the textile article.

Other exemplary embodiments of the invention provide a method of applying cosmetic treatment to a subject in which a textile article as defined above is given to the subject and the actuators are excited in such a manner as to:
move the skin or exert pressure thereon, cyclically or otherwise, e.g. with the actuators being excited prior to the textile article being put into place, so as to cause the textile article to expand, and optionally with excitation being stopped once the textile article is in place, so as to deliver a certain amount of compression on the region in contact with the textile article, and optionally new excitation of the actuators prior to removal of the textile article so as to facilitate such removal, where appropriate with the actuators being excited cyclically once the textile article is in place.

The invention may be better understood on reading the following detailed description of non-limiting implementations thereof, and on examining the accompanying drawings, in which:

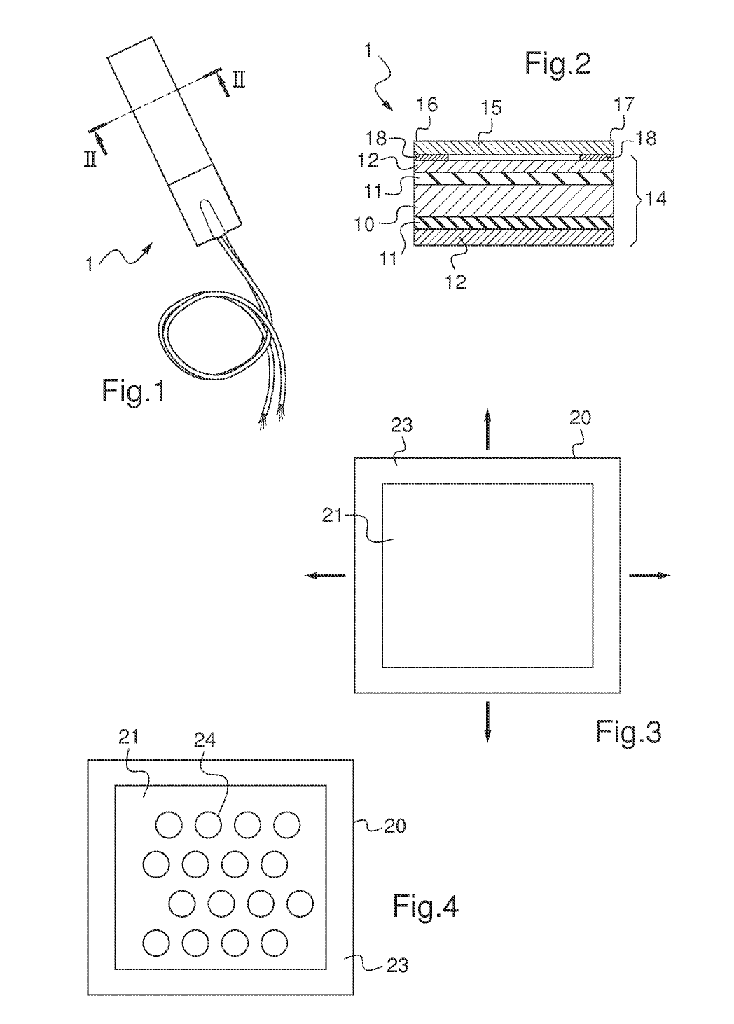

FIG. 1 is a plan view showing an example of an actuator;

FIG. 2 is a section view on II-II of FIG. 1;

FIG. 3 is a plan view showing another example of an actuator;

FIG. 4 is a view analogous to FIG. 3 showing a variant embodiment of an actuator;

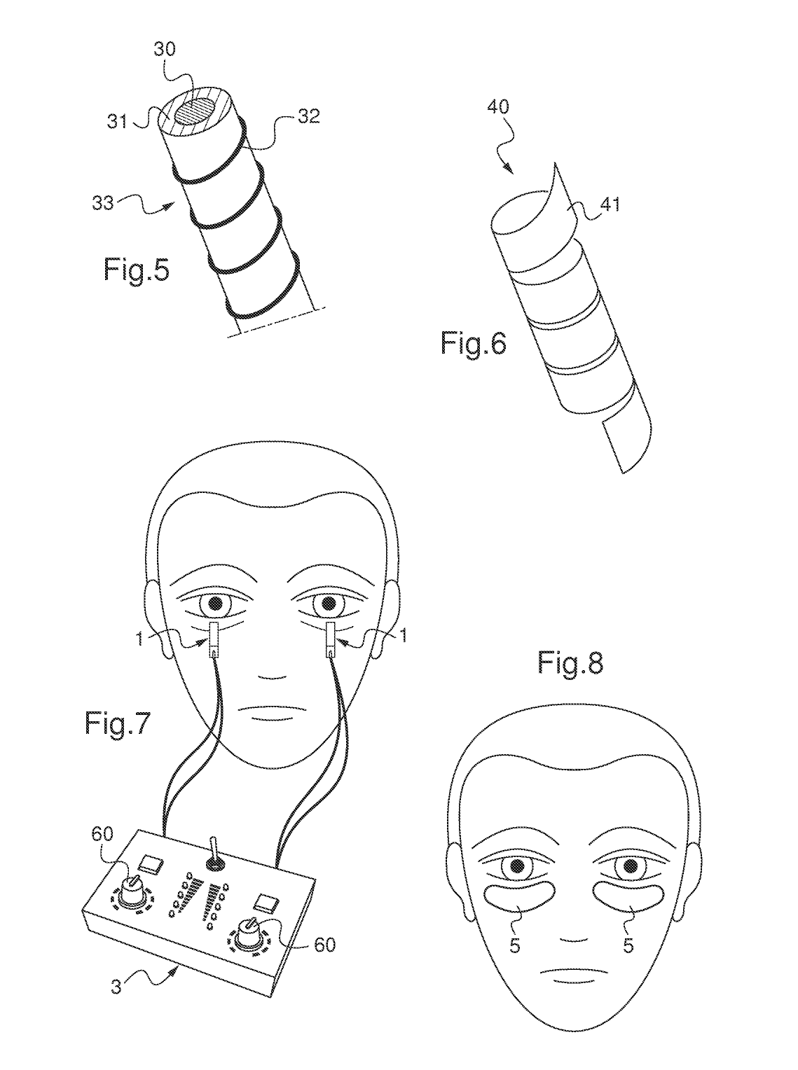

FIGS. 5 and 6 are diagrammatic and fragmentary perspective views showing other examples of actuators;

FIG. 7 shows the use of actuators to act on the lower eyelids;

FIG. 8 shows the eyelids being held stationary by applying a film after the displacements exerted by the actuators of FIG. 7;

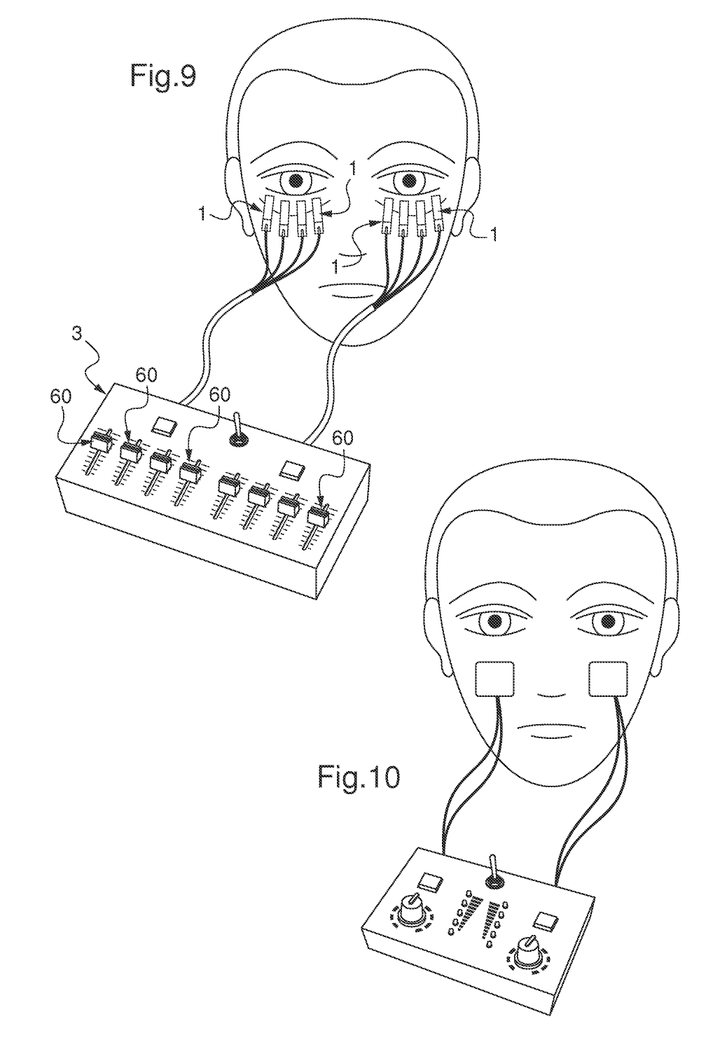

FIG. 9 shows a variant implementation of the method, using a plurality of actuators for each eyelid;

FIG. 10 shows the use of actuators located on the cheeks;

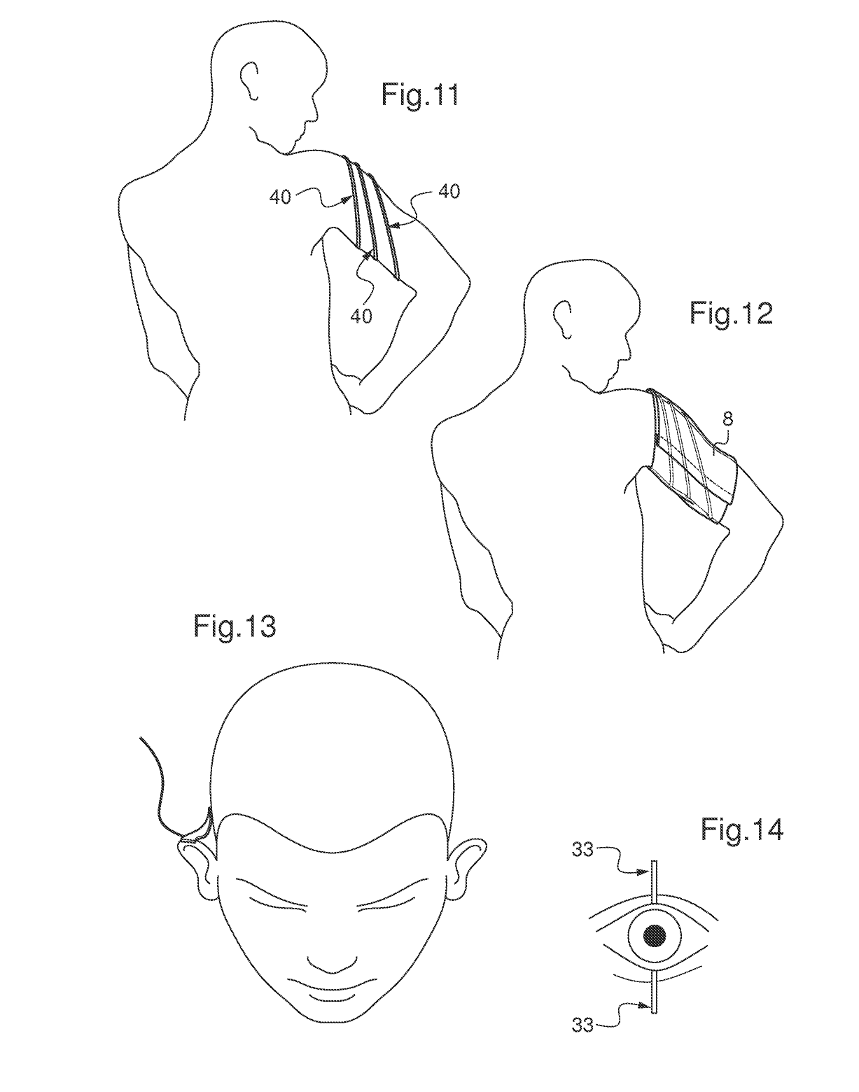

FIG. 11 shows the use of actuators on an arm;

FIG. 12 is a view analogous to FIG. 11, showing a masking film put into place to cover the actuators;

FIG. 13 shows an exemplary embodiments of a method for moving an ear;

FIG. 14 shows the use of actuators for acting simultaneously on a lower eyelid and an upper eyelid;

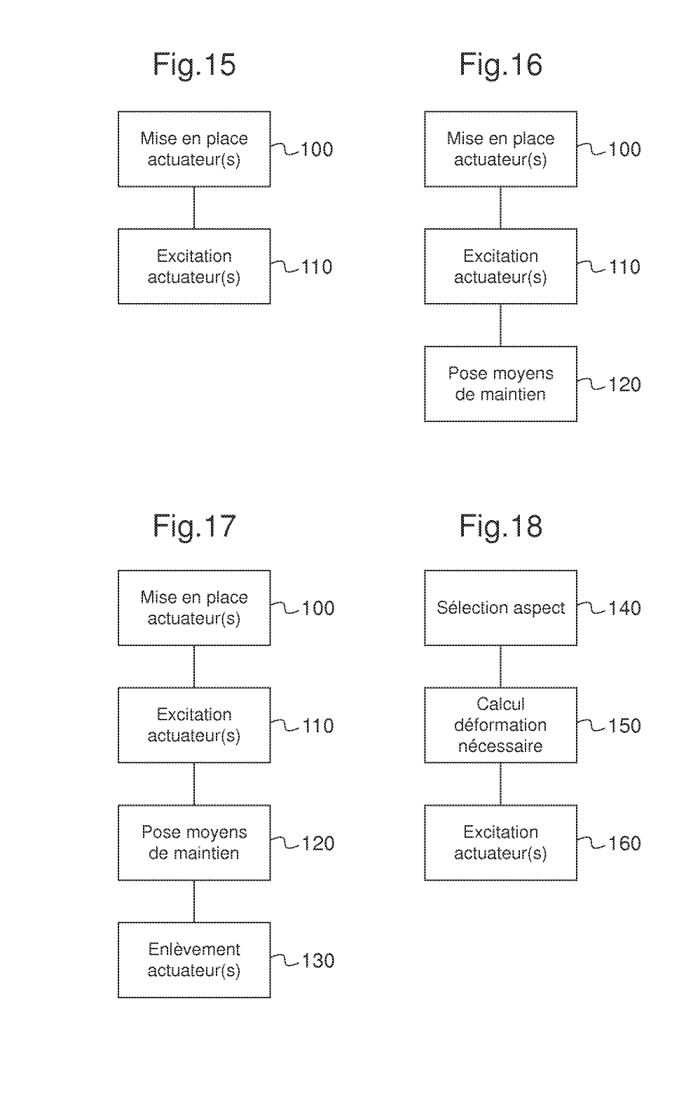

FIGS. 15 to 23 are block diagrams showing different steps in method according to exemplary embodiments of the invention;

FIG. 24 is a plan view of another example of an actuator;

FIG. 25 is a diagrammatic cross-section of the FIG. 24 actuator;

FIGS. 26 to 28 show various ways of positioning the actuators for acting on the bust;

FIG. 29 shows the use of an actuator for acting on the face;

FIGS. 30 and 31 show the use of an actuator for actuating on the region around an eye;

FIG. 32 shows an example of an undergarment incorporating actuators;

FIG. 33 shows an article including an actuator fastened on the body;

FIG. 34 shows another example of how actuators can be positioned;

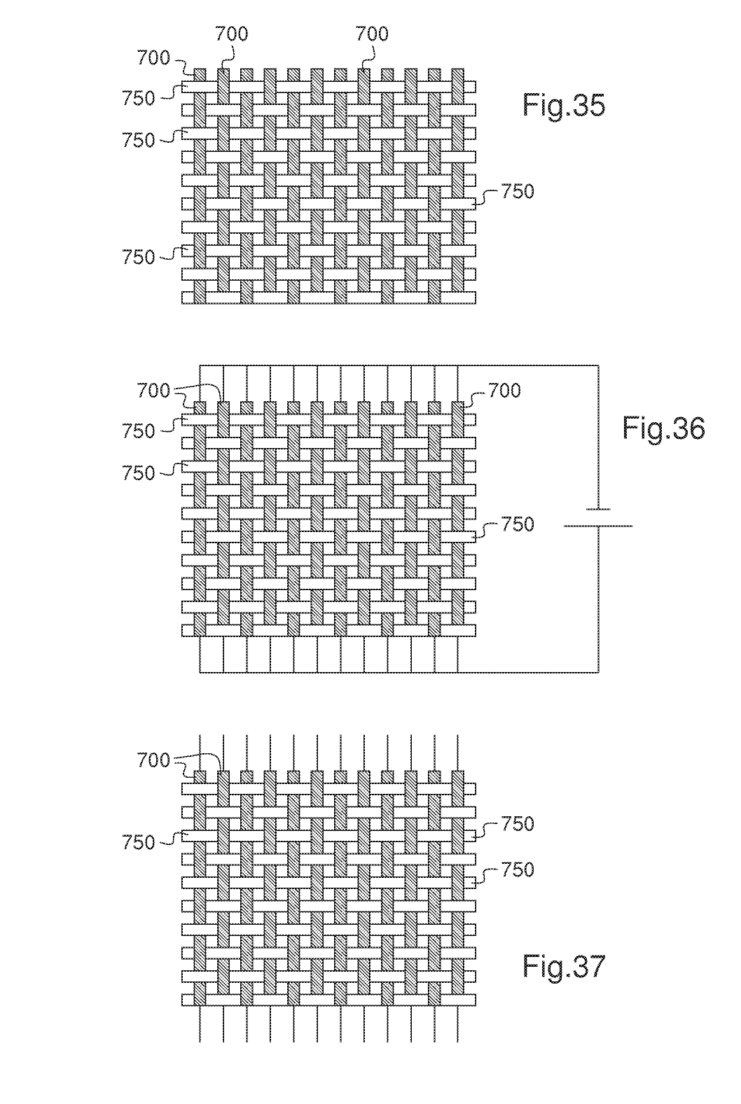

FIGS. 35 to 37 are diagrams showing examples of textile structures incorporating actuators; and

FIG. 38 is a diagrammatic section through an example of an actuator structure.

### ACTUATORS

The invention relates on the use of electroactive material actuators, preferably made of electroactive polymers, and also known as EAP actuators.

The term “electroactive material actuator” is used to designate an actuator that is capable of contracting or expanding in at least one direction because of the presence within the actuator of at least one electroactive material capable of transforming electrical energy into mechanical energy.

Electroactive material actuators include firstly those that are said to be “ionic”, such as those relying for example on the use of polyelectrolyte gels, ionic composites, conjugate polymers, or carbon nanotubes, and secondly those that are said to be “electronic”, e.g. relying on the use of piezoelectric polymers, electrostrictive polymers, dielectric elastomers, or elastomers having liquid crystals and conductive polymers.

The electroactive material is preferably not only sensitive to electric voltage or electric current, but also presents flexibility, for example having the same mechanical behavior as an elastomer.

By way of example, a polyelectrolyte gel comprises a polymer gel made up of an elastomer matrix filled with a liquid.

By way of example, ionic composites may be formed by an ion-exchange polymer metal composite (IPMC), e.g. comprising a polymer membrane including an ionic liquid and covered by metal electrodes, such that applying an electric field causes ions to migrate electrophoretically, thereby causing the membrane to bend.

The actuator may include at least one conductive polymer (CP). A conductive polymer actuator comprises, for example, an electrochemical cell having electrodes constituted by conductive polymers, such that applying a voltage across the cell leads to the cell deforming due to ions being exchanged within the electrolyte.

As an example of conductive polymer actuators, mention may be made in particular of helical polypyrrole-metal actuators, actuators comprising polyaniline fibers covered in a solid electrolyte polymer and in copper, or actuators comprising polyaniline fibers covered in a polypyrrole film.

Dielectric elastomer actuators may comprise a fine elastomer film sandwiched between two electrodes, with the application of voltage causing the polymer film to extend in all the dimensions of the plane. The dielectric elastomer may optionally be shaped to form one or more folds or to be rolled up, e.g. helically.

In general, depending on the electroactive polymer that is retained, the deformation of the actuator may be reversible or non-reversible, taking place essentially in elongation, in bending, in contraction, in one direction, in one plane, or in a volume.

The term “reversible deformation” should be understood as meaning that the actuator may move in a direction opposite to that induced by applying the voltage, either spontaneously due to a resilient return force, e.g. associated with the elasticity specific to the electroactive polymer, or else due to another active component of the actuator, e.g. an electrode. The return force may also be generated by a resilient return member incorporated in the actuator.

The reverse deformation may also take place under the effect of an inverse excitation voltage.

When the actuator is not excited electrically, it may be used as a force or displacement sensor, for example. Under such circumstances, the current or the potential difference created by the actuator may be analyzed to evaluate the mechanical stresses it perceives. This information may be used to monitor the skin and/or to trigger activity of the actuator.

This information may also be used to determine a treatment adapted to the perceived mechanical stresses.

When it is present in the form of a film, the thickness of the electroactive polymer lies for example in the range 1 μm to 2 mm, it being possible, where appropriate, for the electroactive polymer to have been subjected to stretching along one or two axes.

By way of example, the electroactive polymer is placed between two electrodes to which a potential difference is applied. The electrodes may be made of various materials, such as for example: graphite; carbon black; colloidal suspensions; thin layers of metals, e.g. including gold and silver; electrically conductive polymers, for example such as polymers including a filler of conducive particles, e.g. silver or carbon; or ionically conducive polymers. The choice of electrode material may depend on the electroactive polymer.

The electrodes may cover an entire face of the electroactive polymer, or in a variant only a region thereof.

Where appropriate, the actuator may include a plurality of electrodes enabling corresponding regions of the electroactive polymer to be excited. The electrodes may be disposed in an array, for example.

The electrodes may be electrically insulated from keratinous material. In a variant, at least one electrode may come into contact with keratinous material, e.g. for the purpose of performing electrostimulation, optionally simultaneously with excitation of the electroactive polymer.

The voltage suitable for activating the electroactive polymer may depend on the properties thereof, and in particular on its dielectric constant and on its dimensions. For example, the excitation voltage may be less than or equal to 300 V, better 150 V, for example lying in the range 0 to 25 V. This voltage is preferably a low voltage compatible with it being present in the vicinity of keratinous material. If higher voltages are used, it is then ensured that the current cannot exceed a certain limit, and provision is advantageously made for the system to stop in the event of leakage of electricity.

The response of the actuator to the excitation voltage may be linear or non-linear.

The actuator may include at least one film forming a barrier between the active structure of the actuator and the outside, e.g. for the purpose of preventing contact between keratinous material and the active chemical compounds of the actuator. By way of example, the barrier-forming film may be a film of thermoplastic material, e.g. a polyolefin, polyvinyl chloride (PVC), polyester, polyamide, polyurethane, cellulose, . . . .

The actuator may optionally be contained completely within a sealed envelope, e.g. an envelope constituted by a thin film of material that is thermoplastically sealed at its periphery, e.g. a film of transparent thermoplastic material.

Where appropriate, the barrier-forming film may have the same color as the keratinous material or it may be capable of receiving makeup.

The actuator may be fastened to keratinous material in various ways, e.g. by adhesive.

The fastening zones may overlap the electroactive polymer, or in a variant the fastening zones may be offset, the actuator transmitting the force or the displacement via one or more filaments or films or other transmission members lying in line with the actuator.

The barrier-form film may be adhesive, e.g. being covered in a protective coating prior to use. In a variant, the film may be stuck by means of adhesive that is applied extemporaneously.

The actuator may comprise a stack of layers comprising a plurality of layers of electroactive polymers in order to multiply mechanical forces.

The actuator may comprise:
a center layer of an elastically-deformable dielectric material; and
at least two electrode layers on either side of the dielectric material layer, preferably likewise being made of an elastically-deformable material.

The electrode layers may be covered in insulating layers, preferably elastically-deformable layers.

The insulating layers may be made out of the same dielectric material as the center layer.

The dielectric material may be a silicone.

The actuator may be incorporated in a garment or an undergarment.

The actuator may be incorporated in a bra, in a panty girdle, in stockings, in socks, in panties, or in a belt for placing around the abdomen or a limb.

FIGS. 1 and 2 show an example of an actuator 1 suitable for use in exemplary embodiments of the invention.

The actuator 1 is generally in the form of a strip and it retracts when a voltage is applied thereto.

The actuator 1 shown in these figures comprises a membrane 10 of an ionic exchange polymer, e.g. a perfluorinated polymer such as copolymers of tetrafluoroethylene and perfluorinated vinyl ether including —SO₂H or —CO₂H groups as sold by the supplier Dupont under the trademark Nafion.

The membrane 10 of ionically conductive polymer may be covered on each of its faces in a layer 11 of conductive polymer, e.g. polyaniline. This conductive polymer may be covered in a layer 12 of solid electrolyte, e.g. a sulfate salt.

The active structure 14 as formed in this way may be covered, on at least one face, in a protective film 15, e.g. fastened via two opposite ends 16 and 17 to the structure 14 by means of an adhesive 18.

By way of example, such an actuator may be made as follows.

### Example 1

A film 117 of Nafion (supplier Dupont Co.) having thickness of 0.15 mm, width of 10 mm, and length of 30 mm is immersed for 30 min in ethyl alcohol containing 2% of a solid electrolyte, e.g. potassium sulfate. After immersion, the film is withdrawn and allowed to dry. The polyaniline layers are deposited by immersing the film in an (n-methylpyrrolidone) organic solution of polyaniline. The film is allowed to dry at 60° C. for 5 h so as to eliminate the solvent. Thereafter, the film is covered in a layer of solid electrolyte using the same procedure as above. The solid electrolyte layer covers the entire polyaniline film.

FIG. 3 shows another example of an actuator that is designed to work in extension, and that comprises for example an electroactive polymer 20 of the dielectric type covered on both faces in a center zone 21 so as to leave a free peripheral margin 23 in a fatty electrically-conductive compound 24.

The actuator may be covered on both faces by metal electrodes, e.g. made of copper, coming into contact with the compound 24 and with a barrier-forming flexible film stuck to the margin 23.

A barrier-forming film covers the active structure of the actuator and may enable the extension of the actuator to be transmitted to keratinous material, by being stuck thereto.

In the absence of a barrier-forming film, the actuator may be fastened directly via the active structure, e.g. the margin 23, to the keratinous material.

Such an actuator may be made as follows.

### Example 2

A material is prepared comprising a mixture of dielectric silicone elastomer with dispersed titanium oxide. This is done by performing the method described in the article “IEEE transactions on dielectrics and electrical insulation, Vol. 12, No. 4, 2005” incorporated herein by reference.

The dielectric silicone (reference Cine-skin A/B/C 50% silicone, supplier Burman Industries, USA) is mixed with the titanium oxide (30% by weight) (Titanio Biossio—code 488257, supplier Carlo Erba Italy), pre-dried at 100° C. It is dispersed by stirring and then cross-linking sets the mixture at rest in the form of a film having thickness of 1 mm with a side of 50 mm.

Thereafter, the material is covered on both faces in the fatty and conductive compound Nyogel 755G, Technolube seal, USA, on a square having a side of 40 mm.

Flat copper electrodes having a width of 2 mm and a thickness of 200 μm connect the two conductive layers to the voltage generator.

The actuator made in this way is then covered in a barrier-forming flexible plastics film on both sides, the film covering the entire surface thereof and being stuck solely to the edges. The flat electrodes are also covered in the same insulating film.

In the variant embodiment shown in FIG. 4, the layer of the conductive fatty compound is placed to leave gaps 25, also referred to as islands, onto which the barrier-forming electrically-insulative film may be stuck. The number of islands may for example lie in the range 1 to 20.

The presence of islands may enable the extension of the electroactive polymer to be transmitted more uniformly to the barrier-forming film and to the keratinous material to which the film is fastened.

As shown in FIG. 5, the actuator may also be in filamentary form.

The actuator may comprise for example a core 30 of an electrically-conductive polymer, e.g. a core of doped polyaniline, covered in a material acting as the solid electrode matrix 31, one of the electrodes being for example in the form of a wire 32, e.g. a copper wire that is spiral-wound on the sheath 31. The other electrode connects to the polyaniline core.

Such an actuator may be made as follows.

### Example 3

The procedure followed is that described in the article “All polymer actuators for microsystems” by A. Mazzoldi et al., reference: Proceedings of the 3rd Italian Conference on Sensors and Microsystems, World Scientific Publication 1999, Di Natale and D'Amico Editors, pp. 345 to 350, incorporated herein by reference.

In this example, the actuator comprises a doped polyaniline core, covered in a sheath of material acting as a solid electrolyte matrix, i.e. a mixture of propylene carbonate, ethylene carbonate, polyacrylonitrile, and copper perchlorate, having the following respective proportions: 8%, 38%, 13%, and 11%. The entire structure is covered in a copper filament that is spiral-wound on the sheath.

As shown in FIG. 6, the actuator may also present a shape that is helical, e.g. being in the form of a tape 40 molded out of an elastomeric polymer to have a helical shape, being covered on two opposite faces in a material 41 acting as the electrode itself covered in insulation.

By way of example, such an actuator can be made as follows.

### Example 4

An elastomeric silicone is used, e.g. TC 5005, AB-C, BJB Enterprises Inc., USA. It is molded and cut to the shape of a helical coil in the manner described in the article: Smart structures and materials 2005: electroactive polymer actuators and devices, edited by Yoseph Bar-Cohen, Proceedings of SPIE, Vol. 5759, p. 65, incorporated herein by reference. A material acting as an electrode is applied to the two faces of the helical coil, e.g. a mixture of carbon black in a silicone. The entire structure is covered in insulation, e.g. a varnish. This produces an actuator that is generally cylindrical.

### Applications

It is possible to use one or more electroactive polymer actuators on various regions of the body and the face.

As shown in FIG. 15, an example method may comprise a step 100 of placing one or more actuators on the region(s) concerned of the body or the face.

This positioning may be performed by the person concerned or by staff trained for this purpose, e.g. within a beauty institute.

The actuator(s) may be fastened to keratinous material, in particular may be stuck thereto.

The actuator(s) need not be stuck directly to the keratinous material, being merely held in contact therewith.

When sticking to keratinous material, the adhesive is preferably a hypoallergenic adhesive that is deposited on the keratinous material and/or on the actuator at the time it is put into place.

In a variant, the adhesive may already be present on the actuator, e.g. being an adhesive that is sensitive to pressure and hat, prior to use, is covered in a removable protective coating.

When the actuator(s) is/are held in place against the keratinous material without being stuck thereto, this may be done for example by means of a garment or a bandage.

Fastening the actuator on keratinous material may enable a force to be exerted thereon tending to tension, fold, or bend the keratinous material, or to exert pressure thereon.

The force exerted may seek to modify the appearance of the keratinous material, in particular by moving the keratinous material, e.g. skin or flesh, over a distance lying for example in the range 0.2 mm to 4 centimeters (cm), better over the range 0.5 mm to 1 cm.

The displacement may seek to tension the skin, e.g. for the purpose of diminishing the appearance of a wrinkle or other defects such as, for example, orange skin or a roll of fat. The displacement may seek to counter ptosis, for example.

The displacement may also be exerted on hair, for example in order to combat a tuft.

When the actuator is fastened on keratinous material, it may also serve to exert a massaging or exfoliating action.

When the actuator(s) is/are merely held against the keratinous material, without being fastened thereto, excitation of the actuator(s) may for example have the purpose of exerting a massaging action by virtue of relative displacement between the actuator and the underlying keratinous material, and/or for the purpose of exerting rubbing, the massage or rubbing action possibly helping penetration of an active agent or a cosmetic composition or serving to perform an exfoliating action on keratinous material.

A plurality of actuators may be excited sequentially in order to perform a massage, the actuators being for example placed side by side and optionally being secured to a common support.

At least one actuator may be applied against or at least temporarily fastened to an eyelid, in particular a lower eyelid or an upper eyelid, to the forehead, to the cheeks, to the lips, to the neck, to an arm, to the torso, to the stomach, to the breasts, to the buttocks, or to a leg.

An actuator may be put into place on the face in order to modify the appearance thereof. Under such circumstances, and preferably, the actuator is small in size and not very visible, for example being at least partially transparent or covered in a masking film having the same color as the keratinous material, or indeed presenting a face that has the same color as the keratinous material.

Returning to FIG. 15, placing of the actuator(s) is followed by a step 110 of excitation, which excitation may be performed using an appliance that delivers an appropriate voltage, the appliance being located, for example, beside the person while the actuator is being used, or in a variant may be carried by the person, for example the appliance may include means for fastening to the person, such as a belt, or a clip enabling it to be fastened to a belt, for example.

The appliance may have an independent source of electrical energy, e.g. one or more optionally rechargeable batteries, or in a variant it may be arranged to be mains powered. The electrical power supply for the actuator may also be present on the same support as the actuator, as mentioned above.

The actuator may be excited using a single polarity, with the potential difference being greater or smaller depending on the displacement to be induced.

Depending on the actuator being used, the excitation may also be performed with an alternating voltage, of polarity that changes periodically, thereby making it possible to perform a series of expansions and contractions of the actuator or a series of bends in alternating directions.

A plurality of actuators may be excited in such a manner as to combine their forces and induce a larger displacement or greater traction.

The actuator may be powered gradually with electricity so as to induce a displacement that is progressive with a resulting progressive modification to the region of the body on which it is applied, so as to allow the user to determine which modification is best suited to the desired result.

Once the desired displacement has been achieved, fastener means such as an adhesive film or a film-generating polymer may be applied to the region concerned in order to hold it in the state to which it has been taken by the actuator, with this corresponding to step 120 in FIG. 16.

The holder means may be diverse, depending in particular on the keratinous material concerned.

When the material is skin, the holder means may comprise an adhesive film for sticking on the keratinous material. The film is preferably as fine as possible so as to avoid being uncomfortable for the person, and the film may be transparent or suitable for being made up, i.e. its face remote from the keratinous material should present a surface appearance that enables a makeup composition to adhere thereto, in particular a foundation.

The holder means may also comprise a film-generating composition that may be applied while in the fluid state to the keratinous material while it is in the state in which the actuator is holding it.

On curing or drying, the composition forms a film that sticks to the keratinous material and enables it to be held in the configuration to which the actuator has brought it.

Once the holder means have been put into place, the actuator may optionally be removed in a step 130, as shown in FIG. 17, provided such removal does not interfere with the keratinous material being held in the position in which the user desires it to be left.

The user may optionally remove only the electrical conductors for powering the actuator. By way of example, the electrical conductors may be very fine and they may be separated by being broken or cut where they connect to the actuator.

In a variant, miniature electric connectors may be used for connecting the power supply wires of the actuator.

In another variant, the electrical power supply for the actuator is provided via a clip that presses against two opposite faces of the actuator, that include corresponding electrodes. Once the actuator has ceased to be excited electrically, the clip can be removed. The use of such a clip is particularly suitable for actuators that are in the form of a film.

Power may also be supplied to the actuator without contact, by induction, using a coil connected to the actuator, e.g. formed by silkscreen printing or by depositing an electric wire or by etching a metal layer on the same support as the actuator.

In a variant, it is the actuator that serves to hold the region of the body or the skin permanently in the desired state, and there is no need to put holder means into place.

The voltage applied to the actuator may be adjusted by the user acting on a control member of the exciter appliance, such as a knob or a slider, for example. In a variant, the excitation voltage may be determined automatically, by the appliance that is powering the actuator or by a circuit mounted together with the actuator on a common support.

By way of example, the voltage may be increased progressively by the exciter appliance following a programmable ramp. Under such circumstances, the user starts operation and the actuator is excited progressively. The user may stop variation of the applied voltage when the desired result is reached, e.g. by pressing on a button of the exciter appliance.

The actuator(s) may also be excited after a step 140 of selecting a looked-for appearance, as shown in FIG. 18. This selection is performed for example using a screen of the exciter appliance, proposing various appearances for the keratinous material to the user depending on different degrees of excitation of the actuator(s).

Once the appearance has been selected, the method may include a step 150 of calculating modifications to be provided in order to obtain the looked-for appearance, in particular displacements to be exerted on the keratinous material.

This calculation may be performed by a microcomputer on the basis of at least one image of the person on whom the actuator(s) is/are to be fixed, and, where appropriate, on the basis of measurements made on the keratinous material, e.g. the skin.

Once the calculation has been performed, the appropriate voltage(s) is/are applied to the actuators to induce the modifications looked for in step 160.

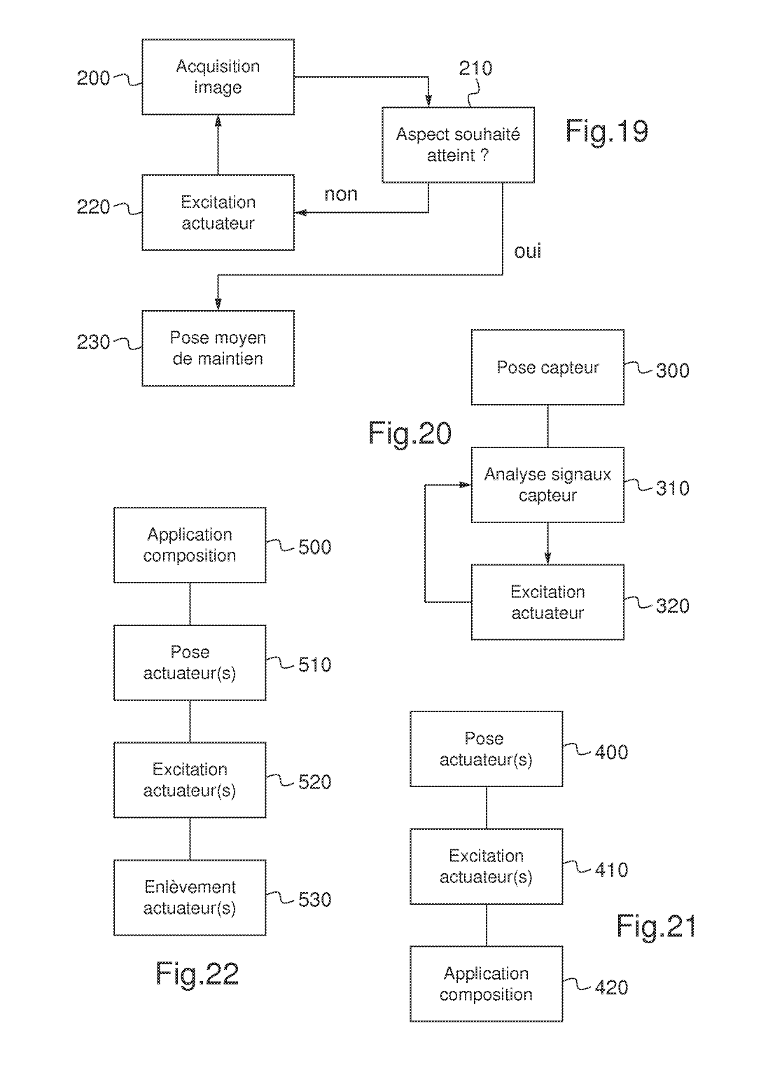

FIG. 19 illustrates a method in which the person wearing the actuator(s) is observed by a camera, in a step 200, and the image is analyzed in a step 210 in order to determine whether the appearance desired by the person has been reached as a result of the displacements induced by the actuator(s).

The excitation of the actuator(s) in step 220 is continued as a function of the analysis as performed in this way in order to come as close as possible to the modified appearance looked for by the person. The actuator(s) may thus be excited using an iterative process, and when the appearance corresponds as well as possible to the looked for appearance, holder means may be put into place in step 230, and excitation of the actuator(s) may then cease.

The action exerted by the actuator may also depend on the response of a sensor, e.g. a sensor that is responsive to displacement of the skin. For example, the actuator may be excited as a function of detecting a displacement of the skin, so as to counter said displacement or control its amplitude.

FIG. 20 illustrates such a method. The method may comprise a step 300 of placing a sensor on keratinous material, e.g. a sensor that is sensitive to displacement of the skin.

Step 310 may consist in analyzing the signals from the sensor so as to act in a step 320 to excite the actuator in the desired manner, e.g. in order to counter the above displacements. The actuator may be used to exert pressure on the keratinous material, e.g. the skin, in order to facilitate penetration of an active agent.

The actuator may exert a pressure that is constant, temporary, or variable over time.

The actuator that is used may in particular be an actuator that is capable of contraction and of extension, depending on the polarity of the applied voltage.

This makes it possible to exert vibration on the skin and/or to perform a massaging action or an action of spreading a composition.

FIG. 21 illustrates the steps of a method of applying a composition by making use one or more actuators.

After a step 400 of putting the actuator(s) into place, the actuator(s) may be excited in a step 410 in order to prepare the keratinous material, e.g. in order to stimulate blood flow, to exert a draining action, or to perform dermabrasion.

Thereafter, in a step 420, the composition is applied after the removal of the actuator(s).

FIG. 22 illustrates another example of the method, in which the composition is initially applied in a step 500, and then the actuator(s) is/are put into place in a step 510, in the region where the composition was applied.

The actuator(s) is/are excited in a step 520, thereby possibly encouraging penetration of the composition, after which the actuator(s) is/are removed in a step 530.

Various example applications are described below.

### Example 5

By way of example, an actuator is used that is made as described in Example 1, however other actuators that shrink when a voltage is applied could also be suitable.

The actuator is stuck via the outside face of the barrier-forming film 15 at one of its two longitudinal ends to the cheek, e.g. using an adhesive based on cyanoacrylate, and the other end of the actuator is stuck to an eyelid, e.g. half a centimeter below the lower eyelid, as shown in FIG. 7.

The voltage may be applied using an appliance 3 that enables the voltage applied to each actuator to be adjusted, the appliance including control means such as a respective button 60 for each actuator, for example.

By way of example, the voltage may vary over the range 0 to 3 V and it may be adjusted to pull on the skin beneath the eyelid, with contraction lying for example in the range 0 to 3 mm approximately.

When the user considers that the desired position has been achieved, this position can be fixed as shown in FIG. 8 by depositing an adhesive holder film 5 onto which foundation makeup may subsequently be applied, e.g. Scotch® 3M®. The adhesive film may be precut to the format of the actuator so as to cover it completely. The electrical conductors may subsequently be separated from the actuator.

### Example 6

In the example of FIG. 9, a plurality of actuators 1 are used to act on each lower eyelid.

A series of actuators 1 are made in accordance with Example 1 each having a length of 30 mm and a width of 4 mm.

In the same manner as in Example 1, each actuator has a flexible barrier-forming film that is stuck to the two ends of the active structure.

Four such actuators are stuck under each eyelid, each extending in a vertical direction, so that the four actuators are substantially in alignment and parallel.

The first is attached under the left eye eyelid substantially at the corner of the eye. The second is offset a little to the left and is attached to the eyelid 8 mm to the left of the corner of the eye. The third is offset to the left relative to the second, and is attached to the eyelid 16 mm to the left of the corner of the eye. Finally, the fourth is offset to the left relative to the third and is attached to the eyelid 24 mm to the left of the corner of the eye.

The same arrangement is implemented using four other actuators in a symmetrical configuration for the other eye.

Each of the eight actuators is electrically connected to an exciter appliance 3 capable of delivering to each actuator a voltage that can be adjusted over the range 0 to 2.5 V.

Each of the actuators is activated with different voltages in order to modify the outline of the eye to match the desired shape. Eight potentiometers 60 may be used for example to adjust individually the voltages applied to each of the actuators.

When the user is of the opinion that the desired position has been obtained, the eyelid is fixed in this position by putting a skin-colored adhesive holder film into place and the wires can be removed.

### Example 7

In this example, as shown in FIGS. 11 and 12, the actuators are used to raise the flesh in a soft region of the body, e.g. flesh of the arms, and to remedy the flaccid appearance of the arm.

By way of example, the actuators 40 of Example 4 are used.

These actuators are 20 cm long and 3 mm in diameter and they are placed around the flesh of the upper part of the arm.

About ten of these actuators are stuck at one end to a hard portion, e.g. level with the shoulder, and they extend downwards around the flesh of the upper portion of the arm.

Under the effect of the excitation voltage, the actuator become tensioned and they lift the flesh of the upper portion of the arms. Where appropriate, the actuators may be hidden under a masking film 8, having the same color as the skin and as shown in FIG. 9.

### Example 8

This example makes use of one or more actuators to act on at least one ear of a person e.g. in order to establish symmetry between the ears in the event of one ear sticking out farther than the other.

To do this, and as shown in FIG. 13, an actuator is fastened at one end to the ear and at the other end to the head behind the ear.

The actuator may be of the ionic polymer type, for example, having a width of 0.5 cm, a length of 2 cm, and a thickness of about 0.25 mm, as sold by the American suppler ERI and suitable for being powered with a voltage that can be varied over the 2 V to 9 V and that can be varied in frequency, as presented in a kit referred to as a “Deluxe Complimentary Package”.

The electrically insulated actuator is stuck by means of a water and alcohol (ethanol) solution of polyacrylic resin along the ear, at the back thereof, and also to the head.

The electrodes are placed at the base of the actuator. The voltage is adjusted so that the ear takes up the desired position, e.g. so as to obtain symmetry of the two ears.

In a variant, the actuator is made up by adding a pigmented cream having the same color as the skin of the user.

In another variant, once the ear has taken up the desired position, an adhesive holder film or a film-generation composition e.g. of the cyanoacrylate type is put into place in order to hold the ear in its new position.

### Example 9

In this example, fiber type actuators as described in Example 3 are used to act on the lower and upper eyelids, as shown in FIG. 14. By way of example the actuators 33 are fastened respectively at one end immediately beneath the eyelashes of the upper eyelid. The actuators may be masked. The actuators are fixed at their other ends to the check and to the eyebrow ridge. By applying a very low voltage, e.g. in the range −1 V to +1 V, it is possible to tension and relax the actuators, thereby varying the shape of the eyelid.

### Example 10

In this example, the actuator is used to apply a fluid composition.

The actuator is placed for example on the cheeks, as shown in FIG. 10, or on the lips (variant not shown), or elsewhere.

By way of example the composition is a composition that includes an anti-aging agent.

By way of example, the actuator is of the type that is capable of producing an extension, or indeed alternating extension/contraction displacements obtained by varying the voltage, as described for example with reference to FIGS. 3 and 4.

The invention is not limited to the above-described examples. In particular, it is possible to use other types of electroactive polymer actuator.

When a composition is applied, the composition may include for example any active agent commonly used in cosmetics, in particular anti-wrinkle agents, moisturizers, sliming agents, vitamins, . . . , and it may be presented in a wide variety of forms.

The composition may include a self-tanning agent, a pigment, a coloring agent, fillers, . . . .

The composition may be an emulsion, e.g. an emulsion of oil in water.

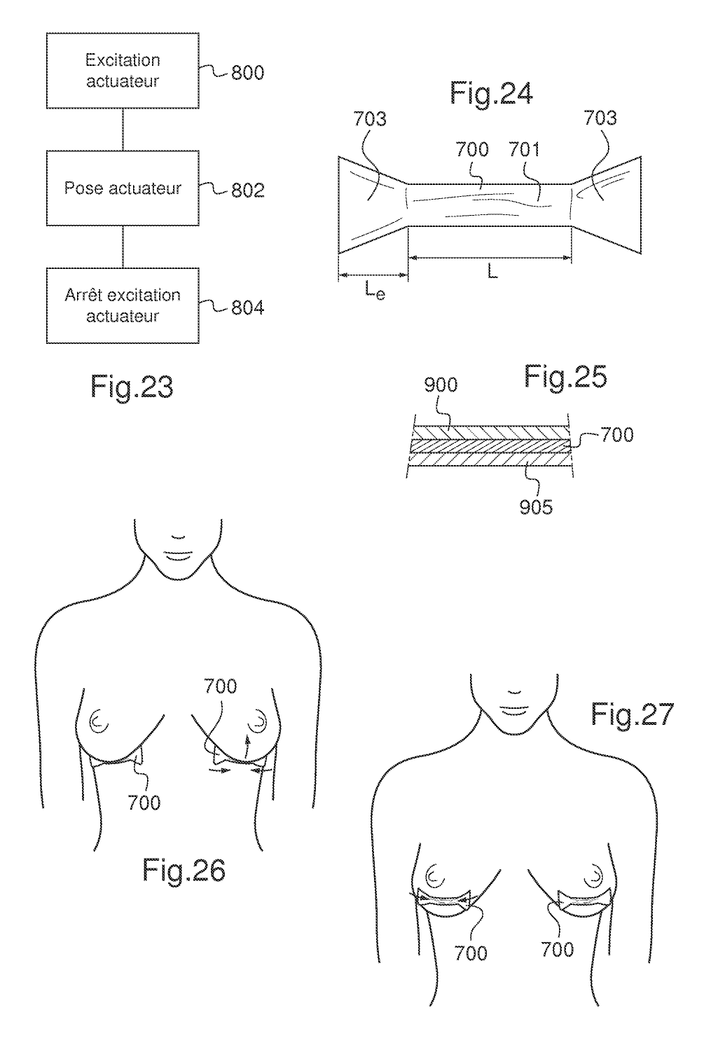

In the examples below, an actuator is used that presents its own elasticity and that is expanded by applying a voltage, as illustrated in step 800 of the diagram of FIG. 23. The applied voltage may be adjusted in order to control the degree of elongation of the actuator, and indirectly the subsequent degree of retraction under the effect of its elasticity.

The actuator may be put into place in the expanded state, corresponding to step 802 in FIG. 23. Thereafter, excitation of the actuator is interrupted, corresponding to step 804, so as to enable the actuator to contract by returning elasticity, and by contracting to exert a force that acts on the body.

Electrical excitation may be maintained over a certain duration while the actuator is in place on the body, or in a variant the excitation may be interrupted prior to the actuator being put into place, in the event that contraction of the actuator following interruption of its electrical excitation does not take place immediately.

### Example 11

### Actuator for Raising the Outline of the Face

The actuator may for example be in the form of a film 700 made up of five layers of dielectric elastomer, as shown in FIG. 38.

The center layer 600 has a thickness of 50 μm, for example. By way of example it is made up of a mixture of dielectric silicone elastomer and dispersed titanium oxide. This may be done by following the procedure described in the article “IEEE transactions on dielectrics and electrical insulation, Vol. 12, No. 4, 2005”.

In one example, the dielectric silicone (referenced Cine-skin A/B/C 50% silicone, supplier Burman Industries, USA), is mixed with titanium oxide (30% by weight) (Titanio Biossio—code 488257, supplier Carlo Erba Italy), that has been pre-dried at 100° C. It is dispersed by stirring and then cross-linking sets the mixture at rest in the form of a film having a length of 100 mm and a width of 20 mm.

The center layer 600 is covered on both faces by respective layers 602 of the same dielectric silicone, but containing particles of carbon black. These two layers form flexible electrodes, e.g. having a thickness of 20 μm.

They are covered on their outer faces by respective 20 μm thick layers of the same dielectric silicone in order to form the outer layers 604, which layers are 20 μm thick, for example.

Since the film of this example is for raising the skin constituting the outline of the face, the length of skin that needs to be raised may be estimated. For this purpose, it is possible for example to press a finger against a corner of the jaw and raise the finger towards the temple. If during this upward displacement the finger moves the skin through a height of 2 cm, it may be decided to perform a face-lift over about half that distance, i.e. 1 cm.

Two electrical conductor wires are placed in the film, so as to come into contact with the flexible electrode layers 602.

Thereafter, a sticky covering is applied on one of the two outer layers 604, e.g. a pressure-sensitive adhesive of the type comprising a 40% solution of AC 1350 (Eastman Chemical).

Without waiting, the two wires are connected to the terminals of a voltage generator G capable of delivering a voltage lying in the range 0 to 10,000 V.

Under the potential difference, the film extends.

The applied voltage V is then adjusted to cause the film to lengthen by the intended distance through which the skin is to move, specifically 1 cm in this example.

Thereafter, the actuator is placed on the skin around the outline of the face, with its adhesive face against the skin, as shown in FIG. 29, for example. After waiting for about 5 min, the electric wires are withdrawn.

At this moment, the film 700 contracts, producing a gentle face-lift to the skin of the face.

Finally, the film may be made up in order to hide it.

### Example 12

### Use of Actuators to Raise the Bust

An actuator of the same structure as in Example 11 is made, except that the shape of the actuator is no longer rectangular, but is as shown in FIG. 24, with a center portion 701 of constant width over a length L and with two end portions 703 of trapezoidal shape, each of length Lₑ, for example. The maximum width of the ends may for example be twice the width of the center portion 701.

In addition, the thickness of the end zones is increased, e.g. being 150 μm.

The film 700 is applied to the portion of the body that is considered to be soft, specifically the bust when it is not sufficiently firm.

Two approaches are possible:

The first consists in anchoring on firm zones, as shown in FIG. 26. Under such circumstances, only the terminal zones 703 of the actuator are coated in adhesive. The potential difference is applied to the two electrode layers. The film 700 is then put into place so that one of the two terminal zones 703 is stuck to a firm zone, specifically on the ribs, and the other is stuck to the low portion of the sternum, so that the breast may rest against the intermediate zone 701 of the actuator.

Once the film has been put into place, the electrical power supply wires are removed after waiting a few minutes. This causes the bust to be raised.

The second approach consists in anchoring on soft portions of the body.

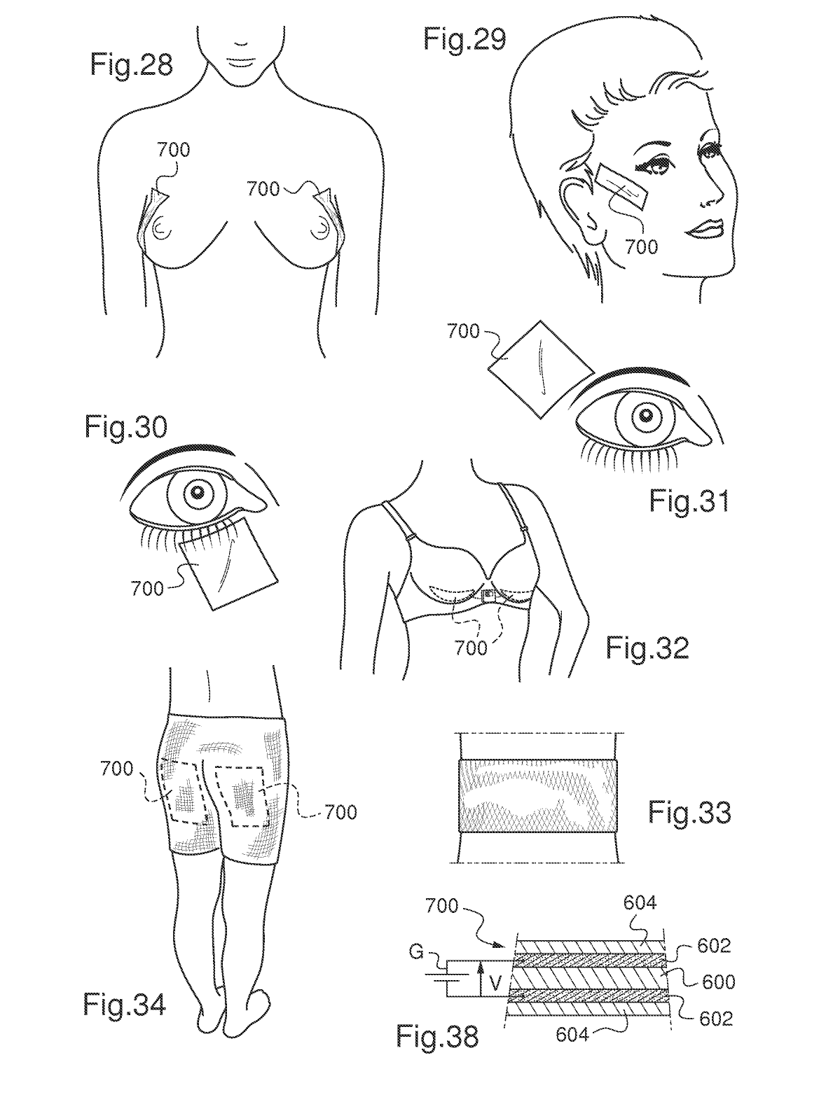

Under such circumstances, the two terminal zones of the actuator are stuck directly to the soft portions, specifically the bottom of the bust or the bottom and the top of the bust, as shown in FIGS. 27 and 28.

In order to stick, the terminals portions 703 are coated in an adhesive. For greater effectiveness, the intermediate zone 701 may also be coated in adhesive. A potential difference is applied to the electrode layers 602. The film 700 is put into place and then the wires are withdrawn.

### Example 13

### Use of an Actuator for Enlarging the Eye by Acting on the Bottom Eyelid

An actuator is made having the same structure as in Example 11, except that the film 700 is only 20 mm long and 20 mm wide.

The center layer 600 has a thickness of only 40 μm, and the electrode layers 602 and the outer layers 604 have a thickness of only 10 μm.

The amount of enlargement that is desired at the end of opening is estimated.

Typically, the amount of opening is selected to lie in the range 500 μm to 2 mm.

A potential difference is applied to the terminals of the two electrode layers 602 so as to cause the film 700 to extend by about twice the looked-for displacement desired for the eyelid. Thus, when the desired extension is 500 μm, the voltage is adjusted so that the film extends by 1000 μm. Specifically, a potential difference (pd) of about 1000 V may be required.

An adhesive, preferably a fast-setting adhesive (e.g. of the cyanoacrylate type) is applied to one of the two outer layers 604.

Thereafter, as shown in FIG. 30, the electrical power supply wires are withdrawn;

The eye then opens through about 500 μm. The elasticity of the device enables the skin to move, e.g. in order to blink.

The actuator may then be made up.

### Example 14

### Use of an Actuator to Enlarge a Slanting Eye by Acting on the Upper Eyelid

An actuator is made having the same structure as in Example 13, except that the film is only 30 mm long and 8 mm wide.

A potential difference is applied to the terminals of the two electrode layers so as to give rise to extension of about 20%. An adhesive, preferably a fast-setting adhesive, is applied to one of the two outer layers.

The film is then applied to the top of the upper eyelid so as to raise the slanting portion, as shown in FIG. 31. If the shape of the eyelid makes this possible, the second outer layer may also be covered in adhesive, and the film may be received in the fold of the eyelid. After application, the wires are withdrawn. Under the effect of the actuator contracting, the eye opens, partially masking the slanting appearance of the eye, while retaining flexibility.

It may be of use to fasten an actuator on the skin, e.g. of the face, that is driven electrically so at to cause it to be subjected to a succession of extension and contraction cycles.

The actuator may be fastened to the skin by means of a pressure-sensitive adhesive.

### Example 15

### Device Suitable for Upkeep of the Face

An actuator is made as described in Example 11, except that the thickness of the center layer 600 is increased, e.g. to 250 μm. In addition, the width and the length thereof are equal to 60 mm.

The treatment may begin with a training stage. This consists in putting the actuator on the skin of the subject, after the skin has been covered in a layer of pressure-sensitive adhesive.

The electrode layers are connected to a generator capable of delivering voltages lying in the range 0 to 10,000 V and also capable of modulating the voltage so that it alternates. The frequency may also be modulated over a range going from 0.001 Hz to 5000 Hz, for example.

The voltage is applied at a starting frequency, e.g. 1 Hz with a peak voltage of 1000 V. Thereafter the peak voltage and the frequency are varied and the subject may inform the operator about which characteristics appear to be comfortable.

It is possible to continue by treating the subject, e.g. regularly every night, on the cheeks or under the eyes using a mode that has been found not to lead to discomfort.

The stressing applied to the inner layers of the skin and the muscles of the skin may serve to reinforce the skin.

### Example 16

### Use of an Actuator to Avoid Stretch Marks

The actuator may be made as in Example 11. The actuator is applied to the skin of the body, more particularly in zones that are likely to suffer from stretch marks.

The actuator may be used during periods in which the body becomes larger and its use may be associated with monitoring weight.

Weight monitoring may serve to determine whether or not the actuator ought to be used, in particular as a function of age and size. The actuator is recommended when taking on weight over certain portions of the body, for example the thighs, the buttocks, the breasts, or the stomach.

Furthermore, the actuator is recommended on the breasts, while menstruating, even if the weight of the model is not increasing.

The actuator may be used as follows:

One of the faces of the actuator is covered in adhesive. A voltage is applied that may be as much as several hundreds of volts to several thousands of volts, using wires connected to the electrode layers. The actuator is then stuck to the portion of the body that is considered to be liable to suffer stretch marks.

After a few minutes, the voltage is removed. The wires may be taken away or left in place. If they are left in place, the voltage may be reapplied regularly so as to lengthen the actuator. After passing several minutes in this state, the voltage is again removed, and so on. These cycles serve firstly to keep under restraint zones that are not to stretch, and also to develop their muscles.

### Mechanically Working the Skin: for Treating Painful Skin and Helping it to Regenerate

When skin has been burnt, it is known that the skin requires help by being massaged, to lengthen it or to compress it. This serves to limit the effect of the regenerating skin hardening.

This principle may be used in relieving skin made painful by the sun. Thus, certain displacements are performed, in particular extension or compression displacements, during the period going from the appearance of erythemia and until it disappears. Indeed there is no need to wait for erythemia to appear, and these displacements may be performed as soon as exposure to the sun has come to an end.

The principle is to make use of an actuator that is applied to the skin, which skin is constrained to stretch and be compressed. Such extension or compression may be maintained over time or else it may be relaxed regularly.

It is possible to perform extension/release or extension/compression or compression/release cycles. It is also possible to apply a cyclically varying potential difference in order to produce a massaging effect.

These methods may be used with or without added compositions. Thus, the actuator films may be pierced with holes that serve, for example, to apply a fatty fluid and allow it to diffuse towards the skin.

It is also possible to cause the film to adhere to the skin by using an adhesive that contains at least one active agent, such as an anesthetic.

### Example 17

### Treating Painful Skin in Extension Mode

An actuator is applied, e.g. an actuator made using the film of Example 11 and of shape in terms of width and length that matches the zone to be treated, e.g. occupying a few square centimeters to several tens of square centimeters.

The actuator is covered on one face in an adhesive. Then two wires are connected to the electrode layers.

The actuator is stuck to the skin. Voltage is applied, e.g. a few hundreds of volts. The skin is held in this way for several hours.

### Example 18

### Treating Painful Skin in Massage Mode

The method is substantially the same as in the above example, except that the voltage is caused to vary at a frequency that may lie in the range 0.001 Hz to 5000 Hz.

Such methods may be used to avoid the skin compacting and to avoid the lack of oxygenation that is caused by certain situations, e.g. for the purpose of treating zones that are naturally vascularized little, e.g. because the subject is in a sitting or prone position, as applies to people who are immobile or traveling, and/or to zones that are made painful by heat, electricity, intense light, sunstroke, surgery, or immersion.

These methods may be also be used with pre-treatments or post-treatments, for example treatments associated with administering or applying anesthetics, analgesics, anti-inflammatory agents, botox,

### Clothing for Skin Care

It is possible to provide clothing such as undergarments, incorporating at least one actuator that is arranged optionally to come into contact with the skin, so as to exert a massage and/or restraining action.

### Undergarments for Skin Care

An actuator, e.g. made in accordance with Example 11, is incorporated in a flexible portion of a garment, e.g. made of a knitted fabric or flexible lace. The actuator is stuck to the inside face of the fabric.

The actuator may cover the same area as all or part of the garment portion.

For an undergarment of the bra type, the actuator may cover the cup zone as shown in FIG. 32. For an undergarment of the panty or panty girdle type, the actuator may cover the buttocks portion, and in particular the region where the buttocks join the thighs, as shown in FIG. 34.

It is also possible to make an undergarment to cover the stomach, consisting of a sheet of fabric that surrounds the stomach, made of a fabric that is sufficiently flexible, e.g. a knitted fabric, as shown in FIG. 33.

In a hidden location of the undergarment, e.g. close to the straps of a bra or close to the waistband of panty girdle, two conductor wires can be connected to the two electrode layers.

Where appropriate, and as shown in FIG. 32, the electricity source may be incorporated in the textile article.

There is no need for the size of the garment to be close fit for the body. For example, if the model is of a size corresponding to 34A, a bra of larger size should be selected: e.g. 36B. If a model is of size 10, then panty girdle for size 12 should be chosen.

Immediately before putting on the undergarment, the actuator is charged by having about 1000 V applied thereto. After the undergarment has been put on, the wires are removed. This gives rise to an effect that relies on the elasticity of the skin and that prevents extension of the skin. This is particularly appropriate for zones that are likely to suffer from stretch marks, and the garment is particularly suitable for periods of weight gain.

In order to take the undergarment off, it may optionally be appropriate to reconnect the voltage in order to enlarge the actuator(s). This makes the garment easy to remove since it returns to its initial size.

This is also applicable to other garments such socks, tights, stockings, shoes, T-shirts, shirts, or gloves, with actuators being particularly suitable for garments that need to be tight against the body in order to remain in place, such as for example stockings, tights, or gloves.

### Example 19

### Leg and Arm Undergarments Having a Depilatory Effect

As shown in FIG. 25, a film 700 made in accordance with Example 11 is incorporated in a flexible garment portion 900, e.g. knitted fabric or flexible lace. The film 700 may be stuck to the outside face of the fabric 900. A second layer of fabric 905, itself likewise flexible, may be applied thereto. Under such circumstances, the film 700 is sandwiched between two layers of fabric, as shown in the example of FIG. 25.

The film may cover the same area as all or part of the garment portion.

With a sock, the film may cover the entire fabric zone. With stockings or tights, the film may cover the bottom zone only, i.e. below the knees. With long gloves that go up the arm, the film may cover the entire area or only the region going from the wrist to the top of the glove.

The film has two wires that are connected to an electricity source.

The fabric of the inside face, i.e. the face that comes into contact with the skin, is selected so as to grip hairs. Thus, certain knits or weaves are used that allow hairs to become jammed in the fabric.

The fabric of the inside face is secured to the film of the actuator, e.g. by adhesive.

Once the garment is in place, e.g. once the socks or the gloves have been put on, the wires are connected to a source of electricity. The source causes the voltage to vary regularly. Cycles may be in the form of sinusoidal oscillations (going from −1000 V to +1000 V, for example), at various frequencies, e.g. of the order of 1 Hz.

Cycles may be in the form of sudden changes of voltage (e.g. in 1 millisecond (ms)), followed by plateaus in which voltage remains constant.

These displacements improve the appearance of the skin by creating an effect that limits the visibility of hairs and that leads to a small amount of peeling, and assisting blood circulation.

It is possible to associate compositions that perform treatment (oils, moisturizers, . . . ) with compositions that provide peeling (abrasive compositions such as alumina), or compositions that provide peeling chemically (glycolic acid in solution), or chemical capillary compositions (based on mercaptan).

### Example 20

### Woven Fabric

Films are made up of strips of actuator film having a length of 10 cm and a width of 3 mm.

Then a weave is made as shown in FIG. 35, associating actuators 700 and yarns 750 other than the actuators. These yarns may be made of cotton, cellulose, flax, polyamide resin, wool, and other artificial or mixed fibers.

The actuators 700 are then connected electrically, as shown in FIG. 36.

Applying voltage causes elongation to take place in a single direction, in the long direction of the actuators 700.

This fabric may be applied directly to the body (being caused to adhere to the surface thereof), or it may form all or part of a garment.

The actuators 700 may also be interconnected in the manner shown in FIG. 37 by connecting them to an electrical power supply system that enables each actuator 700 to be addressed individually. An electronic control system then enables the fabric to be deformed in various ways, e.g. causing some of the fibers to contract but not others.

Finally, the weave used may differ from those shown in FIGS. 35 to 37, e.g. incorporating actuators along two axes, in order to provide greater control over the applied pressure.

The term “comprising a” should be understood as being synonymous with “comprising at least one”.

1. A cosmetic treatment method comprising:
a1) putting into place on keratinous material at least one actuator of electroactive material
b1) exciting the actuator to apply to the keratinous material a force that is substantially parallel thereto and that induces a displacement thereof, which displacement persists, at least while the actuator is in place;
or
a2) exciting the actuator so as to induce deformation thereof;
b2) putting the actuator into place and
c2) modifying the excitation of the actuator, so that the actuator induces a displacement of the keratinous material.

2. The method according to claim 1, comprising steps a2) to c3).

3. The method according to claim 2, wherein the actuator is elastically deformable and the actuator induces displacement of the keratinous material on returning to its initial configuration.

4. The method according to claim 3, wherein the modification of the excitation in step C2) corresponding to stopping excitation.

5. The method according to claim 4, in which the stopping of the excitation is accompanied by disconnection of electrical conductors feeding the actuator.

6. The method according to claim 1, wherein the actuator is used so as to modify the appearance of the bust.

7. The method according to claim 1, wherein the actuator is fastened to the face so as to lift the skin of the outline of the face.

8. The method according to claim 1, wherein the actuator is fastened to the face so as to act on an upper or a lower eyelid, in particular to enlarge an eye.

9. The method according to claim 1, wherein the actuator comes into contact with the skin.

10. The method according to claim 1, wherein the actuator does not come into contact with the skin.

11. The method according to claim 1, wherein the actuator is stuck to the skin or fastened to a garment or an undergarment.

12. The method according to claim 9, wherein the actuator is stuck to the skin via end regions only.

13. The method according to claim 11, wherein the actuator is stuck to the skin with the help of a pressure-sensitive adhesive.

14. The method according to claim 9, wherein the actuator is used to work the skin mechanically in order to develop muscle.

15. The method according to claim 1, wherein the actuator is incorporated in a garment or an undergarment.

16. The method according to claim 15, wherein the actuator is incorporated in a bra, a panty girdle, stockings, socks, panties, or a belt for placing around the abdomen or a limb.

17. An epilation method in which an actuator of electroactive material is placed in contact with the skin, the actuator being secured to a patch, suitable for exerting a depilatory effect on the skin under the effect of displacements of said patch induced by deformation of the actuator.

18. The method according to claim 1, wherein the actuator comprises:
a center layer of elastically deformable dielectric material; and
at least two electrode layers on either side of the dielectric material layer.

19. The method according to claim 18, wherein the electrode layers are covered in insulation layers.

20. The method according to claim 19, wherein the insulating layers are made of the same dielectric material as the center layer.

21. The method according to claim 18, wherein the dielectric layer comprises a silicone.

22. A cosmetic treatment method wherein an actuator of electroactive material is excited cyclically to act on a region of the body of the face, and wherein at least one of the amplitude and the frequency is determined as a function of information coming from the subject on which the actuator is placed.

23. A cosmetic treatment method in which an electroactive material actuator is used to work the skin mechanically after exposure to the sun that might lead to erythemia.

24. A textile article for wearing by an individual comprising a plurality of actuators in the form of yarns.

25. A method of cosmetically treating a subject wherein the subject is provided with a textile article as defined in claim 24, and the actuators are excited in such a manner as to:
move the skin or exert pressure thereon, cyclically or otherwise so as to cause the textile article to expand.

26. A method according to claim 1, wherein the keratinous material is selected from the group consisting of: skin, mucous membranes, and keratinous fibers.

27. The method according to claim 1, wherein the actuators are electroactive polymer actuators.

28. A method of applying a composition on keratinous material, comprising:
exciting an electroactive material actuator so as to exert a force and/or move the keratinous material in the zone where the composition is applied.

29. A kit comprising:
at least one electroactive material actuator; and
at least one composition for applying to the keratinous material.

30. A kit comprising:
at least one electroactive material actuator; and
at least one holder film or film-forming composition for application to the keratinous material in order to hold the keratinous material in a configuration into which the actuator has brought it.

31. A massage device comprising at least one electroactive material actuator and an appliance enabling the actuator to be powered electrically so as to induce periodic displacement of the actuator.

32. A method of fabricating an actuator, in which the actuator is formed by successively depositing electrodes and an electroactive polymer on a keratinous material.

33. A method of fabricating an actuator, wherein the electroactive polymer is molded or shaped while hot, so as to take the shape of the keratinous material onto which the actuator is to be placed.

34. A device for applying to keratinous material, a device comprising an electroactive material actuator and a source of electricity that is incorporated in the device.

35. A sheet device for applying on keratinous material, which device incorporates at least one electroactive material actuator and presents at least one optical layer that produces an optical effect and that is arranged to accompany the mechanical deformation of the actuator with its appearance changing as a function of said deformation.

36. A device comprising:
an electroactive material actuator;
a sensor; and
a circuit for controlling the actuator as a function of at least one signal delivered by the sensor, the actuator being arranged to be fastened on keratinous material.

37. A method of creating a face-lift effect on the skin of the face or of the body, in which the electroactive material actuator is caused to extend by applying a voltage thereto, the actuator is then fastened to the skin, and the electrical excitation of the actuator is modified so as to enable the actuator to shrink.

38. A method of raising the bust in which an actuator is used to which a voltage is applied to cause it to extend, the actuator then having its ends fastened to regions of the body, and then the electrical excitation of the actuator is modified so as to cause the actuator to contract and obtain the looked-for lifting of the bust.

39. A method of modifying the outline of the eye, in which method a voltage is applied to an actuator in order to cause it to become elongated, the actuator is fastened to regions in the vicinity of the eye, and then the electrical excitation of the actuator is modified so as to cause the actuator to shrink and the appearance of the vicinity of the eye to be modified.
